(19) United States
(12) Patent Application Publication
(10) Pub. No.: US 2014/0244438 A1
(43) Pub. Date: Aug. 28, 2014

(54) Eyeglass Frames

(71) Applicants: Kevin Alexander Maurer, Scotts Valley, CA (US); Jillian Kimberly Hitchman, Scotts Valley, CA (US)

(72) Inventors: Kevin Alexander Maurer, Scotts Valley, CA (US); Jillian Kimberly Hitchman, Scotts Valley, CA (US)

(21) Appl. No.: 14/191,387

(22) Filed: Feb. 26, 2014

Related U.S. Application Data
(60) Provisional application No. 61/770,643, filed on Feb. 28, 2013.

(51) Int. Cl. G02C 5/14; G06Q 30/06

(52) U.S. Cl. CPC G02C 5/143; G06Q 30/0617
USPC 705/26.43; 351/118; 705/26.1

(57) ABSTRACT

The present application provides improved eyeglass frames for enhanced comfort, personalization, and aesthetics. The eyeglass frames comprise temples that are proximal to a lens supporting element and temples that are distal to the lens supporting element. The proximal and distal temples form an angle that appears as an upside down “V.” In some embodiments, the frame material is rigid and the angles are fixed. In other embodiments, the frames articulate or pivot in one or more of three locations: between the proximal temple and the frame, between the proximal and distal temples, and between the distal temple and the ear rest. In other embodiments, the frames further comprise attachment elements for attaching ornaments or functional devices.

### FIELD OF THE INVENTION

The present application relates to improved eyeglass frames for enhanced comfort, customization, and aesthetics.

### BACKGROUND

The present invention relates to eyeglass frames for use with corrective lenses, sunglass lenses, and other types of lenses. There are large varieties of eyeglass frames made from many materials known in the art. Likewise, there are large types of corrective and sunglass lenses known in the art. Despite numerous attempts, however, to design eyeglass frames with increased comfort to the user, eyeglass lenses of the prior art have limited comfort and aesthetic appeal. They rely on the classic design of non-articulating temples that run, essentially, straight from the lens stabilization unit or crossbar to the ear.

### SUMMARY OF THE INVENTION

The present application relates to improved eyeglass frames for enhanced comfort, personalization, and aesthetics. In particular, the invention provides eyeglass frames comprising temples that are proximal to a lens supporting element and temples that are distal to the lens supporting element, wherein the proximal and distal temples form an angle that appears as an upside down “V.” In some embodiments, the frame material is rigid and the angles are fixed. In other embodiments, the frames articulate or pivot in one or more of three locations: between the proximal temple and the frame, between the proximal and distal temples, and between the distal temple and the ear rest. In yet further embodiments, the frames comprise attachment structures for attaching ornaments or functional devices.

Thus, the invention provides an eyeglass frame comprising a lens supporting element, two proximal temples extending from the lens supporting element, two distal temples extending distally from each of the proximal temples, two ear rests extending distally from each of the distal temples, wherein each of the proximal temples are rigidly, flexibly or hingedly attached to the lens supporting element. In the flexible or hinged attachment embodiments, the proximal temples may pivot in respective first planes toward the top or bottom of the lens supporting element allowing a user to wear the eyeglass frame at a preferred angle on the face. The proximal temple attachments are additionally flexibly or hingedly attached to the lens supporting element such that the proximal temples pivot laterally in respective second planes allowing the eyeglass frame to fold away for portability or storage. The invention further provides that the distal temples are rigidly, flexibly or hingedly attached to the proximal temples at an angle. In the flexible or hinged attachment embodiments, the distal temples can pivot toward or away from the user's ears. The invention provides that the ear rests are rigidly, flexibly, hingedly, or detachably attached to the distal temple.

In some embodiments, proximal temples are flexibly attached to the lens supporting element by attachments comprising a material selected from the group consisting of plastic, cellulose acetate, cellulose propionate, nylon, a nylon blend, monel, beryllium, flexon, polycarbonate, stainless steel, aluminum, an aluminum alloy, a titanium alloy, nickel, a nickel alloy, gold, a gold alloy, silver, and a silver alloy. In preferred embodiments, the flexible attachments might be a modular attachment element that fits the lens support element and the proximal temples on each end of the attachment. In other preferred embodiments, the lens support element and the proximal temples are one contiguous element and the flexible attachment is an elbow between the lens support element and the proximal temples.

In other embodiments, the proximal temples are hingedly attached to the lens supporting element and the pivoting in the respective first planes is accomplished by hinges selected from the group consisting of case hinges, spring hinges, box hinges, stop hinges, rivet hinges, double jointed hinges, and ball in joint hinges.

In yet other embodiments, the proximal temples are hingedly attached to the lens supporting element and the pivoting in the respective second planes is accomplished by hinges selected from the group consisting of case hinges, spring hinges, box hinges, stop hinges, rivet hinges, double jointed hinges, and ball in joint hinges.

In some embodiments, the distal temples are flexibly attached to the proximal temples by attachments comprised of a material selected from the group consisting of plastic, cellulose acetate, cellulose propionate, nylon, a nylon blend, monel, beryllium, flexon, polycarbonate, stainless steel, aluminum, an aluminum alloy, a titanium alloy, nickel, a nickel alloy, gold, a gold alloy, silver, and a silver alloy. In preferred embodiments, the flexible attachments might be a modular attachment element that fits the proximal and distal temples on each end of the attachment. In other preferred embodiments, the proximal and distal temples are one contiguous element and the flexible attachment is an elbow between the proximal and distal temples.

In other embodiments, the distal temples are hingedly attached to the proximal temples by hinges selected from the group consisting of case hinges, spring hinges, box hinges, stop hinges, rivet hinges, double jointed hinges, and ball in joint hinges.

In some embodiments, the ear rests are flexibly attached to the distal temples by attachments comprised of a material selected from the group consisting of plastic, cellulose acetate, cellulose propionate, nylon, a nylon blend, monel, beryllium, flexon, polycarbonate, stainless steel, aluminum, an aluminum alloy, a titanium alloy, nickel, a nickel alloy, gold, a gold alloy, silver, and a silver alloy. In preferred embodiments, the flexible attachments might be a modular attachment element that fits the distal temples and the ear rests on each end of the attachment. In other preferred embodiments, the distal temples and the ear rests are one contiguous element and the flexible attachment is an elbow between the distal temples and the ear rest.

In other embodiments, the ear rests are hingedly attached to the distal temples by hinges selected from the group consisting of case hinges, spring hinges, box hinges, stop hinges, rivet hinges, double jointed hinges, and ball in joint hinges.

In yet other embodiments, the ear rests are detachably attached to said distal temples by a temple attachment structure selected from the group consisting of latches, clasps, hooks, snaps, screws, rings, springs, pressure sleeves, Velcro®, lock and key structures.

In another embodiment, at least one of said proximal temples, distal temples, or ear rests further comprise an accessory attachment structure selected from the group consisting of latches, clasps, hooks, snaps, screws, rings, springs, pressure sleeves, Velcro®, locks, and keys. In a preferred embodiment, the accessory is an ornament selected from the group consisting of jewelry, chains, amulets, charms, feathers, braids, hairpieces, lights, bands, ropes, leashes, precious stones, semi-precious stones, leather art, string art, fabric art, and plastic art. In another preferred embodiment, the accessory is a functional device selected from the group consisting of a radio receiver, a radio transmitter, an audio speaker, a microphone, a Bluetooth® device, a hearing aid, a hearing amplifier, and a hearing booster.

In another embodiment, the ear rests of the invention comprise a material selected from the group consisting of plastic, cellulose acetate, cellulose propionate, nylon, a nylon blend, monel, beryllium, flexon, polycarbonate, stainless steel, aluminum, an aluminum alloy, titanium, a titanium alloy, nickel, a nickel alloy, gold, a gold alloy, silver, and a silver alloy, a padding, gel, foam, plastic, rubber, cloth, and leather.

The invention provides a business method comprising selling the eyeglass frames disclosed herein. In this embodiment, the accessory attachment structure is a lock that connects with a key to form a two-part lock and key structure. The method comprises the step of offering for sale an ecosystem of ornamental or functional accessories that comprise a key that fits the lock. In a preferred embodiment of the business method, the lock and key are proprietary and the method provides the further step licensing third parties the right to sell accessories comprising the proprietary key.

The invention provides another business method comprising selling the eyeglass frames disclosed herein. In this embodiment, the accessory attachment structure is a key that connects with a lock to form a two-part lock and key structure. The method comprises the step of offering for sale an ecosystem of ornamental or functional accessories that comprise a lock that fits the key. In a preferred embodiment of this business method, the lock and key are proprietary and the method provides the further step licensing third parties the right to sell accessories comprising the proprietary lock.

In another embodiment, the invention provides a business method comprising selling accessories that participate in an ecosystem that attach to the eyeglass frames of the invention by a proprietary lock and key attachment.

In another embodiment, the eyeglass frames comprise a corrective lens selected from the group consisting of single vision, bifocal, trifocal, progressive, adjustable focus, aspheric, and piano.

In another embodiment, the eyeglass frames comprise a sunglass lens selected from the group consisting of black, red, grey, green, brown, yellow, orange, turquoise, blue, purple, polarized, non-polarized, mirrored, gradient, transition, and tinted lenses. In a preferred embodiment, the sunglass lenses can be conveniently removed by a user and replaced with an alternative sunglass lens.

In another embodiment, the lens supporting element comprises a top bar and a bridge. In a preferred embodiment, the lens supporting element further comprises rims for surrounding lenses. In more preferred embodiments, the frames comprise a style selected from the group consisting of butterfly, cat eye, oval, pilot, rectangle, rimless, semi-rimless, round, shield, square, wayfarer™, and wrap.

In another embodiment, the lens supporting element comprises a stop element for controlling over-folding during eyeglass storage. The stop element is mounted on the lens support element or on the proximal temple in proximity to the lens support element. The stop element restricts the lateral folding of the proximal temple in the second plane thereby preventing over-folding of the temples.

In other embodiments, the proximal temples or distal temples are comprised of a material selected from the group consisting of plastic, cellulose acetate, cellulose propionate, nylon, a nylon blend, monel, beryllium, Hexon, polycarbonate, stainless steel, aluminum, an aluminum alloy, titanium, a titanium alloy, nickel, a nickel alloy, gold, a gold alloy, silver, a silver alloy, and a glow-in-the-dark material.

In yet other embodiments, the proximal temples or distal temples comprise one or more electric devices or functional structures selected from the group consisting of LED lights, incandescent lights. LCD lights, LCD displays, fluorescent lights, CFL lights, CCFL lights, and high-intensity discharge lights.

### BRIEF DESCRIPTION OF THE DRAWINGS

FIG. 1 shows an angled view of an embodiment of the invention. An eyeglass frame is shown with a rimmed lens support element, proximal temples, distal temples, ear rests, and accessory mounting structures for optional accessories that attach to the ear rests.

FIG. 2 shows a side view of multiple embodiments of the invention. The lens supporting element is attached to the proximal temple at about a 90° angle. Attachments are shown as structures 1, 2, and 3. The attachments lie between the lens supporting element (4) and the proximal temple (5), between the proximal (5) and distal (6) temples, and between the distal temples (6) and ear rests (7). An accessory attachment structure (8) attached to the ear rest (7) is shown. In this drawing, attachments 1, 2, or 3 are rigid, flexible, or a combination thereof and may be cosmetically indistinct from the proximal (5) or distal (6) temples.

FIG. 3 shows a side view of multiple embodiments of the invention. Hinged attachments are shown as structures 10, 11, 12 and 13. Hinges (10 and 13) lie between the lens supporting element (4) and proximal (5) temple. A hinge (11) lies between the proximal (5) and distal (6) temples. A hinge (12) lies between the distal (6) temples and ear rests (7).

FIG. 4 shows another embodiment of the invention comprising a stop element (9) for controlling over-folding during eyeglass storage.

FIG. 5 shows another embodiment of the invention comprising different accessory attachment structure for a lock (14) and key (15) type attachment that is attached to the distal temple. The “lock” on the frame (14) attaches to an accessory having the “key” (15).

### DETAILED DESCRIPTION OF THE INVENTION

The term “alloy” refers to a mixture or metallic solid solution composed of two or more elements.

The alloys of the invention contemplate alloys of aluminum, bismuth, cobalt, copper, gallium, gold, indium, iron, lead, magnesium, mercury, nickel, potassium, plutonium, rare earth, rhodium, scandium, silver, sodium, titanium, tin, zinc, and zirconium.

The terms “eyeglasses” or “glasses” encompass all types of protective, corrective, assistive and/or fashion eyewear, including but not limited to prescription and non-prescription eyeglasses, reading glasses, sunglasses, sports glasses, safety glasses, surgical glasses, magnification glasses and the like.

The terms “hearing aid” or “hearing amplifier” refer to electroacoustic devices that amplifie and modulates nearby sound for the wearer. The term “hearing booster” refers to an electroacoustic device that amplifies and modulates more distant sounds for the wearer.

The term “lights” as contemplated by the invention include light emitting diode (LED) lights, incandescent lights, liquid crystal displays (LCD), fluorescent lights, compact fluorescent lamps (CFL), cold cathode fluorescent lamps (CCFL), and high-intensity discharge lamps.

The term “plastic” refers to any synthetic or semi-synthetic organic solid that is moldable. Plastics of the invention include organic polymers of high molecular mass and may be derived from petrochemicals or natural materials.

The invention provides for the first time eyeglass frames that have proximal and distal temples that are angled to provide a more functional or aesthetic eyeglass experience. The eyeglass frames may be rigid or alternatively articulate in one or more of three locations: between the proximal temple and the frame, between the proximal and distal temples, and between the distal temple and the ear rest. The articulation allows the temples to pivot toward the top or the bottom of the head allowing the frames to be worn at a custom angle to the face and the temples. In one embodiment, the articulation may be accomplished by a hinge. Eyeglass hinges are well known in the art. In preferred embodiments, said hinges may be case hinges, spring hinges, box hinges, stop hinges, rivet hinges, double jointed hinges, and ball in joint hinges. Exemplary references include U.S. Pat. Nos. 5,009,495, and 8,128,220 and U.S. Pub. Nos. US20130033675 and US20130000077. The foregoing are incorporated by reference in their entirety. In certain embodiments, the hinges of the invention may be adjusted to increase or decrease the tension and thereby adjusting the rigidity of flexion in the hinge. In preferred embodiments, the hinges are adjusted to a custom position and locked in place.

In other embodiments, the eyeglass frames articulate in at least three locations as discussed above but wherein one or more of the articulation points are hinge-less. In this embodiment, the points of articulation flexibly attach two members of the frame. They may be located between the proximal temple and the frame, between the proximal and distal temples, or between the distal temple and the ear rest. Flexible attachments may be defined points along a contiguous frame or temple element or they may be separately manufactured elbows that are connected to the frame or temple elements. In certain embodiments, the flexible attachments are cosmetically identical to, or contiguous with, the temples or ear rests. In other embodiments, the flexible attachments are cosmetically distinct from the temples or ear rests.

Flexible eyeglass frames are known in the art. The flexible eyeglass frames may be comprised of plastic, cellulose acetate, cellulose propionate, nylon, a nylon blend, monel, beryllium, a titanium alloy, flexon, polycarbonate, stainless steel, aluminum, nickel, gold, silver or combinations thereof. In one embodiment, the eyeglass frames are comprised of a highly flexible memory plastic. See, e.g., U.S. Pat. No. 6,719,425 incorporated herein by reference in its entirety. In certain embodiments, flexion is accomplished by hand adjustment at room or ambient temperatures. In other embodiments, flexion is accomplished by applying heat to the flexible attachment points prior to adjusting the flexible attachment angles.

The invention contemplates eyeglasses that include multiple points of articulation between the temple and the crossbar that allow the eyeglasses to be adjusted to suit the needs of the users. Multiple articulations between the proximal end of the temple and the lens support element are known in the art. See, e.g., U.S. Pub Nos. 2006/0279694, 2008/0225225, 2009/0161062, and U.S. Pat. No. 7,625,082, incorporated herein by references in their entirety. The invention further contemplates multi-step injection molding techniques to form in-mold-assembly components that are then incorporated into the finished eyeglasses. The invention further contemplates articulation between the temple and the ear rest. See U.S. Pat. No. 6,588,895, incorporated herein by reference in its entirety.

The invention provides eyeglass frames with proximal and distal temples that articulate across a hinged or non-hinged pivot point. Temple measurements are known in the art and determined from the proximal end of the temple to the end of the temple tip. In preferred embodiments, the proximal temple makes up about 20%, 25%, 30%, 35%, 40%, 41%, 42%, 43%, 44%, 45%, 46%, 47%, 48%, 49%, 50%, 51%, 52%, 53%, 54%, 55%, 56%, 57%, 58%, 59%, 60%, 65%, 70%, 75%, or 80% of the combined length of the proximal and distal temples. In other preferred embodiments, the distal temple makes up about 20%, 25%, 30%, 35%, 40%, 41%, 42%, 43%, 44%, 45%, 46%, 47%, 48%, 49%, 50%, 51%, 52%, 53%, 54%, 55%, 56%, 57%, 58%, 59%, 60%, 65%, 70%, 75%, or 80% of the combined length of the proximal and distal temples.

The eyeglass frames of the invention may further comprise an attachment structure for attaching functional devices. Functional devices associated with eyeglass frames are known in the art. Examples include radio receivers, radio transmitters, audio speakers, microphones, Bluetooth® devices, and hearing aids. Exemplary references include U.S. Pat. Nos. 3,035,127; 5,606,743; 5,717,479; and 6,091,546. The foregoing are incorporated by reference in their entireties. In certain embodiments, the function devices comprise audio transducers (microphone or speakers) that provide audio signals, digital audio data or collect said signals or data recording, digital signal processing or analysis. In this way, the microphone may also provide voice-activated commands to a telephone, a telephone attachment, a personal computer, a networked computer, a computer tablet device, or other wirelessly-connected devices known in the art. In other embodiments, the functional device may include an RF, infrared, a Bluetooth®, cellular 3G, or 4G communication system.

The term “Bluetooth® device” refers to a device that connects to another device using the Bluetooth® wireless technology standard for exchanging data over short distances. This uses short-wavelength radio transmissions in the ISM band from 2400-2480 MHz from fixed and mobile devices, creating personal area networks (PANs) with high levels of security. Bluetooth® devices might include mobile phone headsets, audio speakers, microphones, and other communication devices.

### EXAMPLE 1

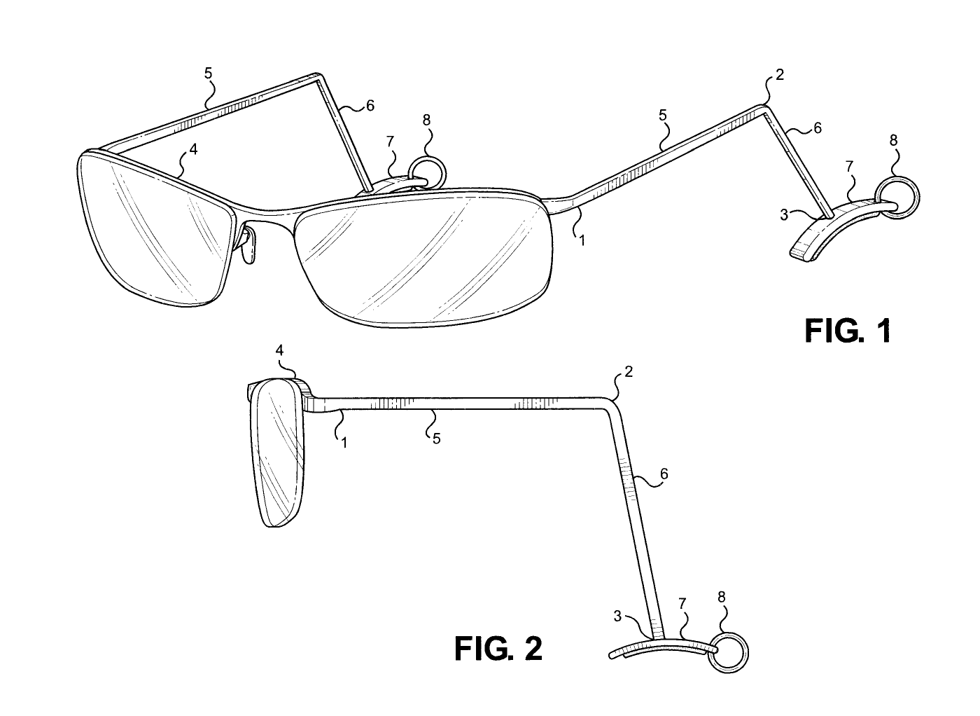

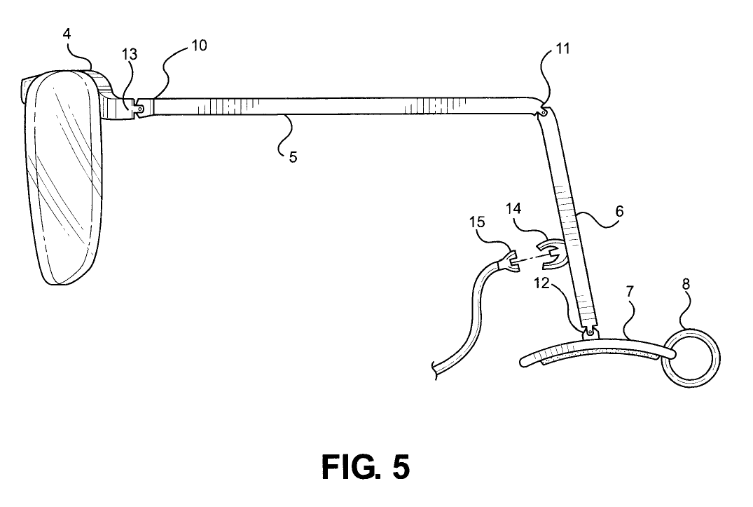

An eyeglass frame is produced having a lens supporting element (4), two proximal temples extending from the lens supporting element (5), two distal temples extending distally from each of the proximal temples (6), and two ear rests extending distally from each of the distal temples (7). See FIGS. 1 and 2. In this example, each of the proximal temples are flexibly attached to the lens supporting element by attachments (1). The flexible attachments allow the proximal temples to (a) pivot in respective first planes toward the top or bottom of the lens supporting element allowing a user to wear the eyeglass frame at a preferred angle on the face and additionally (b) pivot laterally in respective second planes allowing the eyeglass frame to fold away for portability or storage. Also in this example, the distal temples (6) are flexibly attached to the proximal temples (5) at an angle. The flexible attachments allow the distal temples to pivot toward or away from said user's ears. Also in this example, ear rests (7) are flexibly attached to the distal temple. Furthermore, in this example, the flexible attachments are cosmetically indistinct from the temples. An accessory attachment structure (8) is attached to the ear rest (FIGS. 1 and 2) or the distal temple (FIG. 5). In an alternative embodiment, the accessory attachment structure is attached to the proximal temple.

### EXAMPLE 2

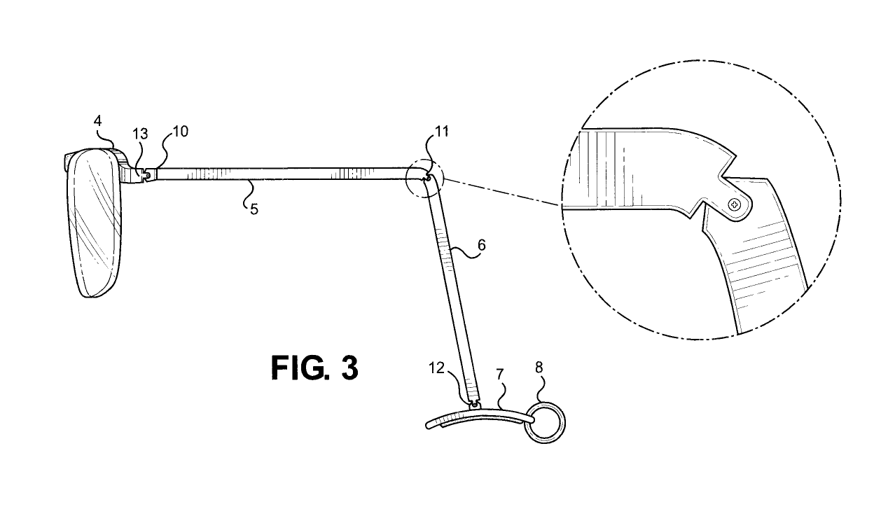

An eyeglass frame is produced having a lens supporting element (4), proximal temples extending from the lens supporting element (5), distal temples extending distally from each of the proximal temples (6), and ear rests extending distally from each of the distal temples (7). See FIG. 3. In this example, each of the proximal temples are hingedly attached to the lens supporting element by attachments (10) and (13). One of the hinges (13) allows the proximal temples to pivot in respective first planes toward the top or bottom of the lens supporting element allowing a user to wear the eyeglass frame at a preferred angle on the face. The other hinge (10) pivots laterally in respective second planes allowing the eyeglass frame to fold away for portability or storage. Thus, the hinges in this example pivot in two planes due to two hinges juxtaposed at a single attachment point between the proximal temple and the lens supporting element. Alternatively, the pivot in two planes may be accomplished by a combination of a hinge and a flexible attachment structure juxtaposed at a single attachment point between the proximal temple and the lens supporting element.

Also in this example, the distal temples (6) are attached to the proximal temples (5) at a hinge (11).

The hinges allow the distal temples to pivot toward or away from the user's ears. Also in this example, the ear rests (7) are attached to the distal temple by a hinge. Connected to the ear rest is an accessory attachment structure (8).

### EXAMPLE 3

An eyeglass frame as described herein but one or both of the attachments between the lens supporting element (4) and the proximal temple (5) or between the proximal (5) and distal (6) temples are rigid. See FIG. 2.

### EXAMPLE 4

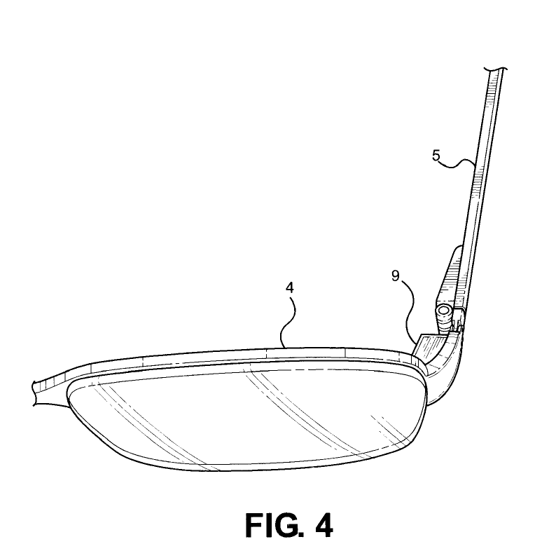

An eyeglass frame from Example 1, 2, or 3 above further comprising a stop element for controlling over-folding during eyeglass storage (9). See FIG. 4. The stop element is mounted on the lens support element or proximal temple in proximity to the lens support element. The stop element restricts the lateral folding of the proximal temple in the second plane thereby preventing over-folding of the temples past the plane of the lens support element and lenses.

### EXAMPLE 5

An eyeglass frame is produced having an accessory attachment structure (14) mounted on a distal temple (6). See FIG. 5. The accessory attachment structure is a “lock” that connects to the “key” found on the attaching accessory (15). In one embodiment, the lock and key form a proprietary “ecosystem” in which only the manufacturer and/or its licensees may participate. Thus, in this embodiment, a business method is provided where an eyeglass or sunglass seller provides glasses having a lock or a key attached to the eyeglass frame and only accessories having a matching key or lock, respectively, will securely attach to the frame. In the business method, the eyeglass or sunglass seller, or its licensees, may sell ornamental or functional accessories that attach to the frame.

All publications and patent documents disclosed or referred to herein are incorporated by reference in their entirety. The foregoing description has been presented only for purposes of illustration and description. This description is not intended to limit the invention to the precise form disclosed. It is intended that the scope of the invention be defined by the claims appended hereto.

What is claimed:

1. An eyeglass frame, comprising:
a. a lens supporting element,
b. two proximal temples extending from said lens supporting element,
c. two distal temples extending distally from each of said proximal temples,
d. two ear rests extending distally from each of said distal temples,
wherein each of said proximal temples are rigidly, flexibly or hingedly attached to said lens supporting element, wherein said flexible or hinged attachments allow said proximal temples to pivot in respective first planes toward a top or bottom of said lens supporting element allowing a user to wear said eyeglass frame at a preferred angle on the face;
wherein said proximal temple attachments are additionally flexibly or hingedly attached to said lens supporting element such that said proximal temples pivot laterally in respective second planes allowing said eyeglass frame to fold away for portability or storage;
wherein said distal temples are rigidly, flexibly or hingedly attached to said proximal temples at an angle, wherein said flexible or hinged attachments allow said distal temples to pivot toward or away from said user's ears; and
wherein said ear rests are rigidly, flexibly, hingedly, or detachably attached to said distal temple.

2. The eyeglass frame of claim I, wherein said proximal temples are flexibly attached to said lens supporting element by attachments comprising a material selected from the group consisting of plastic, cellulose acetate, cellulose propionate, nylon, a nylon blend, monel, beryllium, flexon, polycarbonate, stainless steel, aluminum, an aluminum alloy, a titanium alloy, nickel, a nickel alloy, gold, a gold alloy, silver, and a silver alloy.

3. The eyeglass frame of claim I, wherein said proximal temples are hingedly attached to said lens supporting element and wherein said pivoting in said respective first planes is accomplished by hinges selected from the group consisting of case hinges, spring hinges, box hinges, stop hinges, rivet hinges, double jointed hinges, and ball in joint hinges.

4. The eyeglass frame of claim 1, wherein said proximal temples are hingedly attached to said lens supporting element and wherein said pivoting in said respective second planes is accomplished by hinges selected from the group consisting of case hinges, spring hinges, box hinges, stop hinges, rivet hinges, double jointed hinges, and ball in joint hinges.

5. The eyeglass frame of claim 1, wherein said distal temples are flexibly attached to said proximal temples by attachments comprised of a material selected from the group consisting of plastic, cellulose acetate, cellulose propionate, nylon, a nylon blend, monel, beryllium, flexon, polycarbonate, stainless steel, aluminum, an aluminum alloy, a titanium alloy, nickel, a nickel alloy, gold, a gold alloy, silver, and a silver alloy.

6. The eyeglass frame of claim 1, wherein said distal temples are hingedly attached to said proximal temples by hinges selected from the group consisting of case hinges, spring hinges, box hinges, stop hinges, rivet hinges, double jointed hinges, and ball in joint hinges.

7. The eyeglass frame of claim 1, wherein said ear rests are flexibly attached to said distal temples by attachments comprised of a material selected from the group consisting of plastic, cellulose acetate, cellulose propionate, nylon, a nylon blend, monel, beryllium, flexon, polycarbonate, stainless steel, aluminum, an aluminum alloy, a titanium alloy, nickel, a nickel alloy, gold, a gold alloy, silver, and a silver alloy.

8. The eyeglass frame of claim 1, wherein said ear rests are hingedly attached to said distal temples by hinges selected from the group consisting of case hinges, spring hinges, box hinges, stop hinges, rivet hinges, double jointed hinges, and ball in joint hinges.

9. The eyeglass frame of claim 1, wherein said ear rests are detachably attached to said distal temples by a temple attachment structure selected from the group consisting of latches, clasps, hooks, snaps, screws, rings, springs, pressure sleeves, and lock structures.

10. The eyeglass frame of claim 1, wherein at least one of said proximal or distal temples further comprises an accessory attachment structure selected from the group consisting of latches, clasps, hooks, snaps, screws, rings, springs, pressure sleeves, Velcro®, a lock and a key.

11. An accessory for attaching to the accessory attachment structure of claim 10, wherein said accessory is an ornament selected from the group consisting of jewelry, chains, amulets, charms, feathers, braids, hairpieces, lights, bands, ropes, leashes, precious stones, semi-precious stones, leather art, string art, fabric art, and plastic art.

12. An accessory for attaching to the accessory attachment structure of claim 10, wherein said accessory is a functional device selected from the group consisting of a radio receiver, a radio transmitter, an audio speaker, a microphone, a Bluetooth® device, a hearing aid, a hearing amplifier, and a hearing booster.

13. The eyeglass frame of any one of claim 1, wherein at least one of said ear rests further comprises an accessory attachment structure selected from the group consisting of latches, clasps, hooks, snaps, screws, rings, springs, pressure sleeves, Velcro®, and lock structures.

14. An accessory for attaching to the accessory attachment structure of claim 13, wherein said accessory is an ornament selected from the group consisting of jewelry, chains, amulets, charms, feathers, braids, hairpieces, lights, bands, ropes, leashes, precious stones, semi-precious stones, leather art, string art, fabric art, and plastic art.

15. An accessory for attaching to the accessory attachment structure of claim 13, wherein said accessory is a functional device selected from the group consisting of a leash, tether, radio receiver, a radio transmitter, an audio speaker, a microphone, a Bluetooth® device, and a hearing aid.

16. The eyeglass frame of claim 1 wherein said ear rests comprise a material selected from the group consisting of plastic, cellulose acetate, cellulose propionate, nylon, a nylon blend, monel, beryllium, Hexon, polycarbonate, stainless steel, aluminum, an aluminum alloy, titanium, a titanium alloy, nickel, a nickel alloy, gold, a gold alloy, silver, and a silver alloy, a padding, gel, foam, plastic, rubber, cloth, and leather.

17. The eyeglass frame of claim 1, further comprising a corrective lens selected from the group consisting of single vision, bifocal, trifocal, progressive, adjustable focus, aspheric, and piano.

18. The eyeglass frame of claim 1, further comprising a sunglass lens selected from the group consisting of black, red, grey, green, brown, yellow, orange, turquoise, blue, purple, polarized, non-polarized, mirrored, gradient, transition, and tinted lenses.

19. The eyeglass frame of claim 18, wherein said sunglass lenses can be conveniently removed by a user and replaced with an alternative sunglass lens.

20. The eyeglass frame of claim 1, wherein said lens supporting element comprises a top bar and a bridge.

21. The eyeglass frame of claim 20, wherein said lens supporting element further comprises rims for surrounding lenses.

22. The eyeglass frame of claim 1 comprising a style selected from the group consisting of butterfly, cat eye, oval, pilot, rectangle, rimless, semi-rimless, round, shield, square, wayfarer™, and wrap.

23. The eyeglass frame of claim 20, wherein said lens supporting element comprises a stop element for controlling over-folding during eyeglass storage, wherein said stop element is mounted on said lens support element or proximal temple in proximity to said lens support element, wherein said stop element restricts said lateral folding of said proximal temple in said second plane thereby preventing said over-folding.

24. The eyeglass frame of claim 1, wherein said proximal temples are comprised of a material selected from the group consisting of plastic, cellulose acetate, cellulose propionate, nylon, a nylon blend, monel, beryllium, flexon, polycarbonate, stainless steel, aluminum, an aluminum alloy, titanium, a titanium alloy, nickel, a nickel alloy, gold, a gold alloy, silver, and a silver alloy.

25. The eyeglass frame of claim 1, wherein said distal temples are comprised of a material selected from the group consisting of plastic, cellulose acetate, cellulose propionate, nylon, a nylon blend, monel, beryllium, flexon, polycarbonate, stainless steel, aluminum, an aluminum alloy, titanium, a titanium alloy, nickel, a nickel alloy, gold, a gold alloy, silver, a silver alloy, and a glow-in-the-dark material.

26. The eyeglass frame of claim 1, wherein said proximal temples comprise one or more electric devices selected from the group consisting of LED lights, incandescent lights, LCD lights, LCD displays, fluorescent lights, CFL lights, CCFL lights, and high-intensity discharge lights.

27. The eyeglass frame of claim 1, wherein said distal temples comprise one or more electric devices selected from the group consisting of LED lights, incandescent lights, LCD lights, LCD displays, fluorescent lights, CFL lights, CCFL lights, and high-intensity discharge lights.

28. A business method comprising selling the eyeglass frame of claim 10, wherein said accessory attachment structure is a lock that connects with a key to form a two-part lock and key structure and offering for sale an ecosystem of ornamental or functional accessories that comprise a key that fits said lock.

29. A business method comprising selling the eyeglass frame of claim 10, wherein said accessory attachment structure is a key that connects with a lock to form a two-part lock and key structure and offering for sale an ecosystem of ornamental or functional accessories that comprise a lock that fits said key

30. The business method of claim 28, wherein said lock and said key are proprietary and comprising the further step of licensing third parties the right to sell accessories comprising said proprietary key that fits said proprietary lock.

31. The business method of claim 29, wherein said lock and said key are proprietary and offering licensing third parties the right to sell accessories comprising said proprietary lock that fits said proprietary key.

32. A business method comprising selling accessories that participate in an ecosystem that attach to the eyeglass frame of claim 10 by a proprietary lock and key attachment.
